(19) United States
(12) Patent Application Publication
(10) Pub. No.: US 2008/0305287 A1
(43) Pub. Date: Dec. 11, 2008

(54) Producing Method of Transfer Body with Organic Film Thermal-Transferred Thereon and Transfer Body with Organic Film Thermal-Transferred Thereon

(75) Inventors: Hiroshi Ohata, Saitama (JP); Satoshi Miyaguchi, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 11/997,439

(22) PCT Filed: Jul. 31, 2006
(86) PCT No.: PCT/JP2006/315158

§ 371 Date: May 29, 2008

(30) Foreign Application Priority Data
Aug. 1, 2005 (JP) 2005-222573

(51) Int. Cl. B41M 5/26

(52) U.S. Cl. 428/32.39; 156/230

(57) ABSTRACT

A production method of a transfer body with an organic film thermal-transferred thereon, which can be preferably inhibit the mass transfer from occurring, is provided.

After a convex structure 1 which is a step structure which is formed around an outer edge of a position of a thermal transfer receptor on a surface of a substrate 10 and higher than an outer edge of the position of thermal transfer receptor is disposed, with a donor sheet 200 which is an organic film-forming body on a surface of which a hole injection layer 162 is formed, light energy due to laser 210 is coverted into thermal energy, to thermal-transfer the hole injection layer 162 from a surface of the donor sheet 200 on a surface of the substrate 10, to produce a transfer body with an organic film thermal-transferred thereon.

### TECHNICAL FIELD

The present invention relates to a producing method of a transfer body with an organic film thermal-transferred thereon and a transfer body with an organic film thermal-transferred thereon, and, in particular, a producing method of a transfer body with an organic film thermal-transferred thereon, in which heat energy is applied to the organic film forming body on a surface of which an organic film is formed, the formed organic film is thermal-transferred from a surface of the organic film forming body to a surface of a thermal transfer receptor to produce a transfer body with an organic film thermal-transferred thereon, and a transfer body with an organic film thermal-transferred thereon.

### BACKGROUND ART

An organic EL device is a device which includes, on a substrate, electrodes, and an organic solid layer including at least a light-emitting layer between the electrodes, where electrons and holes are injected from the electrodes on both sides to a light-emitting layer in an organic solid layer to causes light-emission in the organic light-emitting layer. The organic EL device is capable of obtaining high brightness emission. Furthermore, since light-emission from an organic compound is used, the organic EL display device has a feature in that a selection range of light-emission color is wide; accordingly, it is expected as a light source, an organic EL display device, and the like. In particular, the organic EL display device is generally excellent in the wide viewing field, high contrast, high-speed response, and visibility; accordingly, it is expected as a flat panel display that is thin, lightweight, and low in the power consumption.

As a method of patterning an organic material used in an organic EL display provided with such an organic EL device, a method where a metal mask called a shadow mask and having fine openings is disposed in front of a substrate and in a vacuum an organic material is heated and deposited to form a desired pattern (shadow mask method), and a method where an organic material soluble in an organic solvent is patterned by use of an ink-jet printing method may be cited.

In recent years, as shown in non-patent literatures 1 and 2 below, a technology called LITI (Laser Induced Thermal Imaging) where an organic material is once formed on an entire surface of a desired area of a member called a donor sheet, with an organic film of the donor sheet (organic film forming body) disposed in a faced manner with a substrate (thermal transfer receptor) on which an organic film is wanted to be formed, and laser is irradiated with a predetermined width from a surface side on which an organic film of the donor sheet is not formed, and light of an irradiated portion thereof is converted into heat to thermal-transfer the organic film from the donor sheet to the substrate, is reported. The technology is reported to be excellent in the transfer performance in comparison with the shadow mask method, and the ink-jet printing method, to be preferable in high definition pixelation of an organic EL display device.

Non-patent literature 1: SID 02 Digest 21.3 p 784 to 787
Non-patent literature 2: FPD International Seminar 2004, “Production Technology of Large Size Organic EL Device (6)” Text E-6

### DISCLOSURE OF THE INVENTION

### Problems that the Invention is to Solve

However, when the inventors transferred an organic film from a donor sheet to a substrate according to the LITI method, and examined an organic film-thermal transferred substrate on which the organic film had been transferred, the inventors found that, in some cases, the transfer performance was not good.

That is, it was found that, when an organic film is thermal-transferred according to the LITI technology, in some cases, an organic film is also transferred on a portion other than a portion corresponding to a portion of a donor sheet where laser is irradiated for the substrate, that is, an organic film is unfavorably transferred on a portion outside of a desired portion, in which the organic film should not be transferred, and the transfer performance is not good (in the specification, also referred to as “mass transfer”).

Furthermore, as the result of inventors' study, it was found that the inconvenience of the mass transfer is caused not only in an organic film used in an organic EL display device, but also in an organic film in general, and furthermore, is caused not only when a thermal transfer receptor is a substrate but also it is a general thermal transfer receptor. Still furthermore, the mass transfer is, in some cases, caused not only in the LITI method, but also in a general method where an organic film forming body such as a donor sheet is used to thermal-transfer on a thermal transfer receptor.

The invention has been carried out in view of the above problems, and it is an object of the invention to provide a producing method of a transfer body with an organic film thermal-transferred thereon, which can more preferably inhibit the mass transfer from occurring, and a transfer body with an organic film thermal-transferred thereon.

### Means for Solving the Problems

The invention according to claim 1 relates to a producing method of a transfer body with an organic film thermal-transferred thereon, comprising:

applying heat energy on an organic film-forming body on a surface of which an organic film is formed, to thermal-transfer the formed organic film from a surface of the organic film-forming body to a surface of a thermal transfer receptor to produce a transfer body with an organic film thermal-transferred thereon,

wherein, as to a surface of the thermal transfer receptor, a step structure formed higher than an outer edge of a position of the thermal transfer receptor before the thermal transfer is disposed at least partially on the outside equal to or beyond an outer edge of a position of the thermal transfer receptor, and

the organic film is thermal-transferred on a surface of a thermal transfer receptor to form a transfer body with an organic film thermal-transferred thereon.

The invention according to claim 7 relates to a transfer body with an organic film thermal-transferred thereon, which is formed by applying heat energy on an organic film-forming body on a surface of which an organic film is formed to thermal-transfer the formed organic film from a surface of the organic film-forming body to a surface of a thermal transfer receptor,

wherein, as to a surface of the thermal transfer receptor, a step structure formed higher than an outer edge of a position of the thermal transfer receptor before the thermal-transfer is disposed at least partially on the outside equal to or beyond an outer edge of a position of the thermal transfer receptor.

### BRIEF DESCRIPTION OF THE DRAWINGS

FIG. 1 is a schematic explanatory diagram of a producing method of a transfer body with an organic film thermal-transferred thereon in the exemplary embodiment.

FIGS. 2A, 2B, 2C and 2D each are a diagram showing a sectional shape of a step structure in the exemplary embodiment.

FIG. 3 is a schematic sectional view of an organic EL device in the exemplary embodiment.

FIG. 4 is a schematic sectional view of an organic EL display device of example 1.

### DESCRIPTION OF REFERENCE NUMERALS

1: Step structure (convex structure)
10: Substrate
14: First Electrode
16: Organic Solid Layer
18: Second Electrode
20: Protective Film
100: Organic EL Device

### BEST MODE FOR CARRYING OUT THE INVENTION

### [Study of Step Structure]

The inventors studied reasons why the mass transfer is caused. As the result, a phenomenon in that, when dirt is adhered on a surface of a thermal transfer receptor, the mass transfer in that the thermal transferring is applied to a portion that is around the dirt and outside of a desired portion and where the thermal transferring should not be applied, is inhibited from occurring, was fortuitously found.

While a reason why, when the dirt adheres, the mass transfer is inhibited from occurring, was being studied, a hypothesis in that, owing to the dirt, to a transfer receptor portion on a surface of a desired thermal transfer receptor, to a height of the dirt, a step is formed, thereby, the step can inhibit the mass transfer from occurring, was made.

In order to verify the hypothesis, modes where various steps are disposed were tested. For instance, when a convex structure was disposed on a surface of a thermal transfer receptor and in the neighborhood of a boundary between a portion where an organic film should not be transferred and a portion to which an organic film is transferred so that a surface of the convex structure may be higher than a portion to which an organic film is transferred to provide a step structure, and the transfer performance of the state was verified, it was found that the mass transfer could be preferably inhibited from occurring. Furthermore, it was found that, when a structure where a portion to which an organic film is transferred was concaved on a surface of a body to which the thermal transfer is applied and where an organic film should not be transferred is prepared, and, a step higher than a portion to which an organic film is transferred is disposed between the portion to which an organic film should not be transferred and a portion to which an organic film is transferred to verify the transfer performance thereof, the mass transfer could be preferably inhibited from occurring.

As the result of such various verifications, it was found that, when, after a step structure is disposed at least partially higher than a surface of a thermal transfer receptor around a position of a thermal transfer receptor, the organic film is thermal-transferred, a transfer body with an organic film thermal-transferred thereon which can preferably inhibit the mass transfer from occurring and could obtain preferable transfer performance can be produced.

[Producing Method of Transfer Body with Organic Film Thermal-Transferred Thereon]

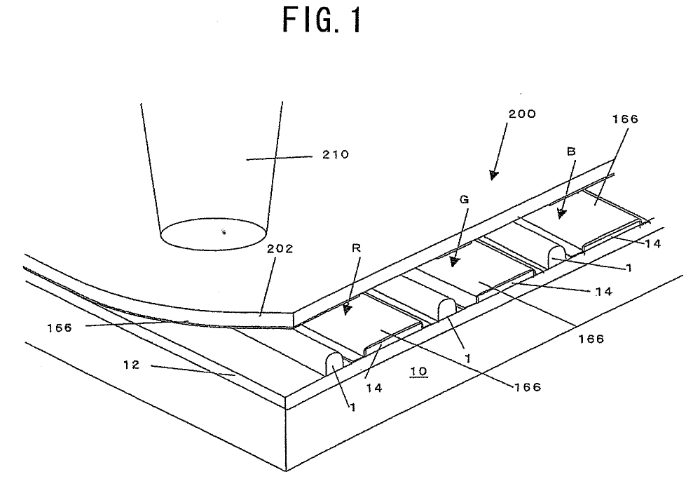

With an aspect where a light-emitting layer 166 is thermal-transferred on a hole transporting layer 164 illustrated in FIG. 1, a producing method involving the exemplary embodiment of a transfer body with an organic film thermal-transferred thereon will be described. In the exemplary embodiment, as an example, a thermal-transferring method that uses a LITI process is described. Furthermore, an organic EL device 100 produced by separately coating (separate coating method) organic EL devices that emit the respective colors of RGB is illustrated and described.

As shown in FIG. 1, on a substrate 10 (in particular, in case of a resin substrate, precisely, it is on a barrier film 12; however, for the convenience of description, a surface of a substrate 10 is taken. Hereinafter, the same.), rows of positive electrodes 14 which are a first electrode corresponding to each of R, G, B are disposed respectively with a predetermined separation. In the next place, on the positive electrode 14 that is a formed first electrode 14, a hole injection layer 162 (not shown in FIG. 1) and a hole transporting layer 164, respectively, are formed to form a thermal transfer receptor in which a hole transporting layer 164 (not shown in FIG. 1) is a thermal transfer receptor surface.

In the next place, on the outside equal to or beyond an outer edge of a thermal transfer receptor surface to which a light-emitting layer 166 is thermal-transferred (substantially a portion to which a laser-beam is irradiated on a surface of a substrate 10 described below), a convex structure 1 having a continuous structure is disposed. When the convex structure is disposed, a step structure is formed so that a surface of the convex structure 1 on a surface of a first electrode 14 can be heightened.

Disposing a step structure on the outside equal to or beyond an outer edge of a thermal transfer receptor surface is a concept in that a step structure is disposed on an outer edge or outside thereof. Furthermore, it is sufficient that a step structure is high for an outer edge of a thermal transfer receptor surface prior to the thermal transfer (for instance, in the exemplary embodiment, it is sufficient that a height of the convex structure 1 (step structure) is higher than a hole transporting layer 164 (a thermal transfer receptor surface)), and a portion other than a thermal transfer receptor surface is not inhibited from becoming higher than the step structure. Still furthermore, it is sufficient that a step structure is higher than a thermal transfer receptor surface before the thermal transfer, and it is sufficient that an outer edge of an organic film transferred after the thermal transfer becomes higher than the step structure.

An organic film may be any organic film which can be thermal-transferred at least a little from an organic film-forming body on a thermal transfer receptor surface, and can be appropriately selected from a material of a film that is formed by thermal transfer, and used. A film which contains organic material is sufficient, and inclusion of the other components such as an inorganic oxide and a metal is not inhibited from containing.

It is preferable that a step structure such as the convex structure 1 is formed with a definite distance from an outside of a thermal transfer receptor surface. That is, in the exemplary embodiment, the convex structure 1 is a process in which an outer edge of the first electrode 14 of a surface of the substrate on which a light-emitting layer 166 is thermal-transferred is formed in a straight line, and it is preferable that the convex structure 1 is formed on a surface of the substrate 10 in parallel with a straight line of the outer edge and outside thereof. Being in parallel is preferred. However, without restricting thereto, a straight line or a curved line may be formed.

The step structure such as the convex structure 1 is preferred to be a continuous row-type structure. However, without restricting thereto, the step structure may be formed into a surface structure where a surface made of only a surface of the substrate 10 (a convex structure 1 is not formed) and a convex structure 1 in which a convex structure 1 is formed on a surface of the substrate 10 are discontinuously formed. Furthermore, without restricting to a condition where a plurality of point-like step structures are disposed, a point-like step structure may be singularly disposed. It is sufficient that a step structure is at least partially disposed in a portion at least on the outside equal to or beyond an outer edge of a position of a thermal transfer receptor.

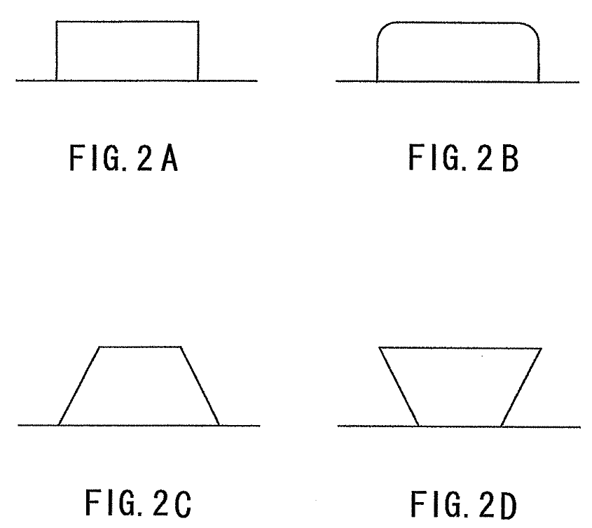

FIGS. 2A, 2B, 2C and 2D are diagrams each showing a cross-sectional shape of a step structure such as a convex structure 1 or the like.

As shown in FIGS. 2A, 2B, 2C and 2D, in the invention, a cross-sectional shape of a step structure may be, without restricting to particular one, any shape, as far as it produces an effect of the step structure. The cross-sectional shape of the step structure may be, for instance, a cornered rectangle as shown in FIG. 2A, or a rectangle with round corners as shown in FIG. 2B. Furthermore, it may be a forward tapered shape as shown in FIG. 2C, or an inverse tapered shape as shown in FIG. 2D.

The step structure such as the convex structure 1 may be formed according to an appropriately selected method without restricting to a particular one. The step structure may be formed according to, for instance, a method where a substrate 10 is etched by wet etching. In addition to the above methods, a sputtering method and a CVD method may be cited. However, general thin-film forming methods such as a vacuum deposition method, an ion plating method, a sol-gel method, a spin coat method, a spray coat method, and a CVD method may be used as well. When an organic film is formed, a spin coat method, a printing method, or a vapor deposition method may be used to form. The step structure such as the convex structure 1 or the like may be formed of either of an inorganic material or an organic material, without restricting to particular one, and an appropriately selected material may be used.

Furthermore, the convex structure 1 and the substrate 10 are not necessarily joined to each other. For instance, a method where a convex structure 1 is simply placed on a substrate, that is, a method where the convex structure 1 is physically separable from the substrate may be used. Still furthermore, when a step structure is disposed, a thermal transfer receptor surface of a substrate 10 to which a light-emitting layer 166 is thermal-transferred may be etched, and lowered than the surrounding thereof to dispose a step.

It is sufficient that the step structure such as the convex structure 1 is formed at least when a corresponding organic film is thermal-transferred on a substrate 10, and it is acceptable that, before and after the thermal transfer, the step structure such as the convex structure 1 or the like is not formed or is eliminated.

The step structure such as the convex structure 1 may be formed so as to surround, as shown in the exemplary embodiment, both sides of a thermal transfer receptor surface or four sides thereof or more than that. However, only the step structure such as the convex structure 1 or the like corresponding to one outer edge may be disposed.

The step structure such as the convex structure 1 or the like and an outer edge of a thermal transfer receptor surface may be brought into contact with each other. However, these are preferably separated from each other.

In the next place, a light-emitting layer 166 (organic film) corresponding to each of R, G and B is transferred on a surface of a hole transporting layer 164 of the substrate 10 by means of the LITI method. Specifically, from a donor sheet 200 as an organic film surface-forming body on a surface of which a light-emitting layer 166 (organic film) is formed, a light-emitting layer 166 (organic film) is thermal-transferred on a thermal transfer receptor surface of the substrate 10 by irradiating a laser 210 from a back surface side of the donor sheet to the substrate 10.

The donor sheet 200 includes a light-emitting layer 166 (organic film) portion formed on a surface thereof, and a photo-thermal conversion portion 202 having the photo-thermal conversion capacity by which light energy is converted to thermal energy.

A material of the photo-thermal conversion portion 202 is not particularly restricted, as far as it is appropriately selected and used so that the light-emitting layer 166 (organic film) can be thermal-transferred.

The kind of laser used in the thermal transfer, an irradiation time, an irradiation amount per unit time, and an output, without particularly restricting, can be appropriately selected and used.

The laser 210 is irradiated on the photo-thermal conversion portion 202 of the donor sheet 200 from the back side so as to substantially correspond to a thermal transfer receptor surface of a surface of the substrate 10, and scanned. Due to the irradiation and scanning, a light-emitting layer 166 (organic film) formed on a surface of the donor sheet 200 is thermal-transferred on a thermal transfer receptor surface on a surface of the substrate 10, thereby, a transfer body with an organic film thermal transferred thereon where a light-emitting layer 166 (organic film) is thermal-transferred on a surface of the substrate 10 or on a surface of the hole transporting layer 164 is produced. Similarly, layers which form the other organic solid layers 16 are also formed, thereby, an organic solid layer 16 made of, from a positive electrode 14 side, a hole injection layer 162/a hole transporting layer 164/a light-emitting layer 166/an electron transporting layer 167/an electron injection layer 168, can be formed.

Furthermore, as to a method of separately coating R, G and B, in this method, a method where after, for instance, with an R donor sheet, an organic film is coated, a donor sheet of G or B is thermal-transferred according to the LITI process on a thermal transfer receptor surface in a corresponding surface of the substrate, is cited.

In the exemplary embodiment, the mass transfer where also on a portion other than a portion corresponding to a donor sheet to which laser is irradiated for the substrate, an organic film is thermal-transferred, that is, on a portion that is outside of a desired portion and where the thermal transfer should not be applied, an organic film is unfavorably thermal-transferred, can be preferably inhibited from occurring, thereby a transfer body with an organic film thermal transferred thereon can be produced with a good performance of transfer. Thereby, for instance, in case of a full-color display, R, G, and B can be preferably separately coated to be able to form a full-color display with high definition pixelation.

A producing method of a transfer body with an organic film thermal-transferred thereon of the exemplary embodiment is preferably used in an organic EL display device, because an organic EL display device tends to be particularly adversely affected by the mass transfer. According to the method, the mass transfer in that the thermal transfer is unfavorably applied on a portion which is outside of a desired portion and should not be thermal-transferred, is preferably inhibited from occurring, and thereby an organic EL display device can be produced with excellent transfer property; accordingly, the high definition pixelation can be preferably attained.

In the exemplary embodiment, a formation method of an organic solid layer of an organic EL device has been illustrated. However, the producing method of a transfer body with an organic film thermal-transferred thereon may be generally used as well in a method where an organic film is thermal-transferred. The producing method may be applied as well to, for instance, a layer that forms a barrier film or a protective film in the exemplary embodiment. Furthermore, the producing method may be applied as well to a field where the transfer of a color filter and an organic light-emitting device material, and precise patterning are required. The producing method may be applied to not only an organic EL display device but also a general display such as a liquid crystal display, an electrophoretic display, an electronic paper, and a toner display.

In the exemplary embodiment, the LITI process was used. However, without restricting thereto, the producing method may be generally applied to a method where light is converted into thermal energy to thermal-transfer an organic film. Furthermore, the producing method can be generally applied to a method where an organic film is transferred on a thermal transfer receptor surface, and a method of generating thermal energy is not restricted to a method where light is converted into thermal energy by a donor sheet. For instance, a heat ray may be irradiated, or a printing method according to a hot-melt transfer type such as a printer that uses a thermal head may be used. In this instance, in some cases, the donor sheet does not necessitate a photothermal conversion material. In the exemplary embodiment, a first electrode is used as a positive electrode; however, it goes without saying that the first electrode may be used as a negative electrode.

### [Organic EL Device]

In the following, the exemplary embodiment of the invention will be described with reference to the drawings. The exemplary embodiment is only one mode for carrying out the invention, and the invention is not restricted to the exemplary embodiment.

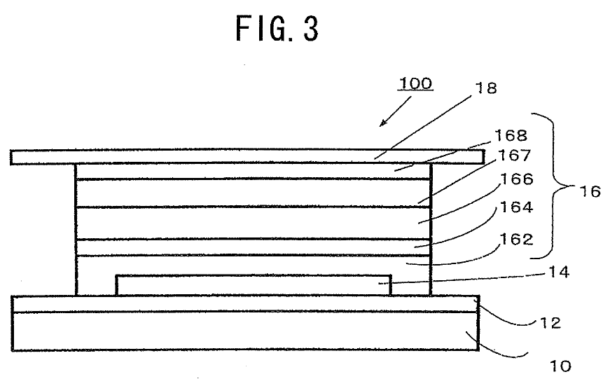

In FIG. 3, a cross-sectional view of an organic EL device 100 produced according to a producing method of a transfer body with an organic film thermal-transferred thereon shown in FIG. 1 is shown.

A substrate 10 may be appropriately selected from a glass substrate, a resin substrate, and so on, and used. Examples of the resins include a thermoplastic resin, a thermo-setting resin, polycarbonate, polymethyl (meth) acrylate, polyarylate, polyethersulfone, polysulfone, polyethylene terephthalate polyester, polypropylene, cellophane, polycarbonate, cellulose acetate, polyethylene, polyvinyl chloride, polystyrene, polyamide, polyimide, polyvinylidene chloride, polyvinyl alcohol, a saponified material of ethylene-vinyl acetate copolymer, a fluorinated resin, chlorinated rubber, an ionomer, an ethylene-acrylic acid copolymer, and an ethylene-acrylic acid ester copolymer. Furthermore, not a substrate mainly made of a resin, but a glass substrate, and a glass and plastic-laminated substrate may be used. Furthermore, an alkali-barrier film or a gas-barrier film may be coated on a substrate surface. Still furthermore, when a top emission type where light is emitted to a transparent substrate from an opposite side is used, the substrate 10 is not necessarily transparent.

A barrier film 12 is not necessarily formed, when a glass substrate is used. However, when the barrier film is formed, the EL device can be preferably protected from erosion due to moisture and oxygen from a substrate side. In the case of the barrier film 12 being formed, a material may be appropriately selected, and used.

The barrier film 12 may have a multi-layer structure or a single layer structure, and may be made of an inorganic material film or an organic material film. However, when an inorganic material film is contained, the barrier property against the erosion due to moisture or oxygen can be preferably improved.

As the inorganic film, for instance, a nitride film, an oxide film, or a carbon film, or a silicon film may be adopted. More specific examples thereof include a silicon nitride film, a silicon oxide film, a silicon oxynitride film, a diamond-like carbon (DLC) film, and an amorphous carbon film. That is, nitrides such as SiN, AlN, and GaN, oxides such as SiO, Al₂O₃, Ta₂O₅, ZnO, and GeO, oxynitrides such as SiON, carbonitrides such as SiCN, metal fluorides, and a metal film may be cited.

Examples of the organic films include a furan film, a pyrrole film, a thiophene film, a polyparaxylene film, or a film made of a polymer such as an epoxy resin, an acrylic resin, polyparaxylene, a fluorine-based polymer (perfluoroolefin, perfluoroether, tetra fluoroethylene, chlorotrifluoroethylene, and dichlorodifluoroethylene), metal alkoxide (CH₃OM, C₂H₅OM, and the like), a polyimide precursor, or a perylene-based compound.

As the barrier film 12, a laminate structure made of at least two kinds of substances, a laminate structure made of an inorganic protective film, a silane-coupling layer, and a resin-sealing film, a laminate structure made of a barrier layer made of an inorganic material, and a cover layer made of an organic material, a laminate structure made of a compound made of a metal or a semiconductor and an organic material such as Si—CXHY and the like, and an inorganic material, a laminate structure where an inorganic film and an organic film are alternately laminated, and a laminate structure where SiO₂ or Si₃N₄ is laminated on a Si layer, may be cited. An organic EL device 100 is constituted by laminating, from a barrier film 12 side, a positive electrode 14/an organic solid layer 16/a negative electrode 18.

It is sufficient that as the positive electrode 14, a layer having an energy level which is easy to inject holes is used, and it is possible that a transparent electrode such as ITO (Indium Tin Oxide) is used. However, when an organic EL display device is a top emission type, without using a transparent electrode, a general electrode may be used.

A transparent conductive material such as ITO is formed into a thickness of, for instance, 150 nm by use of a sputtering method. Without restricting to ITO, in place thereof, a ZnO film, IZO (indium zinc oxide alloy), gold, copper iodide, and the like may be adopted as well.

An organic solid layer 16 is constituted of, from a positive electrode 14 side, a hole injection layer 162/a hole transporting layer 164/a light-emitting layer 166/an electron transporting layer 167/an electron injection layer 168.

A hole injection layer 162 is disposed between a positive electrode 14 and a hole transporting layer 164 to promote the injection of holes from a positive electrode 14. Due to the hole injection layer 162, a driving voltage of an organic EL device 100 can be lowered. Furthermore, in some cases, the hole injection layer 162 plays a role of stabilizing the hole injection to extend the lifetime of the device and of covering an uneven surface such as protrusions formed on a surface of the positive electrode 14 to reduce device defects.

It is sufficient that a material of a hole injection layer 162 is appropriately selected in such a manner that an ionization energy thereof is between a work function of the positive electrode 14 and an ionization energy of the hole transporting layer 164. For instance, a triphenylamine tetramer (TPTE) or copper phthalocyanine may be used.

The hole transporting layer 164 is disposed between the hole injection layer 162 and the light-emitting layer 166, and promotes the transportation of holes to appropriately transport holes to the light-emitting layer 166.

It is sufficient that a material of a hole transporting layer 164 is appropriately selected in such a manner that an ionization energy thereof is between the hole injection layer and the light-emitting layer 166. For instance, TPD (triphenylamine derivative), or NPB (N,N-di(naphthalene-1-yl)-N,N-diphenyl-benzidine) may be adopted.

The light-emitting layer 166 is a layer that recombines transported holes and similarly transported electrons (mentioned below) to cause fluorescent emission or phosphorescent emission. As for the light-emitting layer 166, it is sufficient that a material is appropriately selected so as to satisfy the nature which can correspond to the emission mode. For instance, an aluminum quinolinol complex (Alq₃), and π-conjugate polymers such as a bis(benzo quinolinolato) beryllium complex (BeBq), a tri(dibenzoylmethyl)phenanthoroline europium complex (Eu(DBM)₃(Phen)), ditolylvinyl biphenyl (DTVBi), poly(p-phenylenevinylene), and polyalkylthiophene, may be used. When green emission is desired, for example, an aluminum quinolinol complex (Alq₃) may be used.

The electron transporting layer 167 is disposed between an electron injection layer 168 and the light-emitting layer 166, and plays a role of transporting electrons to the light-emitting layer 166. The electron transporting layer 167 may be composed of, for instance, an aluminum quinolinol complex (Alq₃).

The electron injection layer 168 is disposed between the electron transporting layer 167 and a negative electrode 18, and has a role of promoting the injection of the electrons from the negative electrode 18.

It is sufficient that a material of the electron transporting layer 168 is appropriately selected so as to be between a work function of the negative electrode 18 and the electron affinity of the light-emitting layer 166. For instance, as for the electron transporting layer 168, a thin film (such as 0.5 nm) made of lithium fluoride (LiF), lithium oxide (Li₂O) or the like may be adopted.

The respective layers constituting the organic solid layer 16 are usually made of organic materials, and the organic material may be a low molecular weight organic material or a high molecular weight organic material. In the exemplary embodiment, at least one layer is produced according to the LITI method. Layers other than the above may be produced according to another producing method of a transfer body with an organic film thermal-transferred thereon, or the other method. However, an entirety of layers may be produced according to the LITI method, or a producing method of a transfer body with an organic film thermal-transferred thereon other than the above. As the other methods, for instance, an organic solid layer made of a low molecular weight organic material may be generally formed by means of a dry process (vacuum process) such as a vapor deposition method or the like, and an organic solid layer made of a high molecular weight material may be generally formed by means of a wet process such as a spin coat method, a blade coat method, a dip coat method, a spray coat method, and a printing method.

Examples of organic materials used in the respective layers which constitute an organic solid layer 16 include, as polymers, PEDOT, polyaniline, a polyparaphenylenevinylene derivative, a polythiophene derivative, a polyparaphenylene derivative, polyalkylphenylene and a polyacetylene derivative.

In the exemplary embodiment, the organic solid layer 16 has been described with a configuration that is constituted of a hole injection layer 162, a hole transporting layer 164, a light-emitting layer 166, an electron transporting layer 167, and an electron injection layer 168. However, the organic solid layer 16, without restricting thereto, may well be constituted containing at least a light-emitting layer 166.

For instance, depending on the characteristics of organic materials and the like which are adopted, in addition to a single layer structure made of a light-emitting layer, a two layer structure provided with a hole transporting layer/a light-emitting layer, a light-emitting layer/an electron transporting layer or the like, a three layer structure provided with a hole transporting layer/a light-emitting layer/an electron transporting layer, or a multi-layer structure further provided with a charge (hole, electron) injection layer, may be constituted.

Furthermore, the organic solid layer 16 may be provided with a hole blocking layer between the light-emitting layer 166 and the electron transporting layer 168. The holes may go through the light-emitting layer 166 to reach the negative electrode 18. For instance, in the case where Alq₃ or the like is used as the electron transporting layer 168, the holes may flow into the electron transporting layer to result in emission of Alq₃, or the holes may not be confined in the light-emitting layer to lower the emission efficiency. In this connection, a hole blocking layer may be disposed to inhibit the holes from flowing in the electron transporting layer 168 from the light-emitting layer 166.

As for the negative electrode 18, in order to promote the electron injection to the organic solid layer 16, a material small in the work function or the electron affinity may well be selected. For instance, an alloy type (mixed metal) such as a Mg:Ag alloy, an Al:Li alloy or the like may be preferably used. As the negative electrode 18, a metal material such as Al, Mg or Ag may be formed into a thickness of, for instance, 150 nm by means of the vacuum deposition or the like.

The protective film 20 may be formed into a multi-layer structure or a single layer structure, and may be formed of an inorganic film or an organic film. However, when an inorganic film is contained, the barrier property by which moisture or oxygen is inhibited from eroding is preferably improved; however, the protective film 20 is not necessarily an indispensable constituent.

As the inorganic film, for instance, a nitride film, an oxide film, a carbon film, or a silicon film, or the like, may be adopted. More specific examples thereof include a silicon nitride film, a silicon oxide film, a silicon oxynitride film, a diamond-like carbon (DLC) film, and an amorphous carbon film. That is, nitrides such as SiN, AlN, GaN and the like, oxides such as SiO, Al₂O₃, Ta₂O₅, ZnO and GeO, oxynitrides such as SiON, carbonitrides such as SiCN, a metal fluoride compound, and a metal film are cited.

Examples of the organic films include a furan film, a pyrrole film, a thiophene film, a polyparaxylene film, or a film made of a polymer such as an epoxy resin, an acrylic resin, polyparaxylene, a fluorine-based polymer (perfluoroolefin, perfluoroether, tetra fluoroethylene, chlorotrifluoroethylene, and dichlorodifluoroethylene), metal alkoxide (CH₃OM, C₂H₅OM, and the like), a polyimide precursor, or a perylene-based compound.

As the protective film 20, a laminate structure of at least two kinds of substances, a laminate structure of an inorganic protective film, a silane-coupling layer, and a resin-sealing film, a laminate structure of a barrier layer made of an inorganic material and a cover layer made of an organic material, a laminate structure of a compound made of a metal or a semiconductor and an organic material such as Si—CXHY and the like and an inorganic material, a laminate structure where an inorganic film and an organic film are alternately laminated, and a laminate structure where SiO₂ or Si₃N₄ is laminated on a Si layer, may be cited.

In the barrier film 12 and the protective film 20, a constituted organic film buries pin-holes and surface unevenness formed in the inorganic film to flatten a surface. Furthermore, in some cases, the organic film may play a role of alleviating the film stress of the inorganic film.

As a producing method of the protective film 20, a sputtering method and a CVD method may be cited. However, without particularly restricting, an appropriate one may be preferably used. General thin film forming methods such as a vacuum deposition method, an ion plating method, a sol-gel method, a spray coat method, a spin coat method, and a CVD method, may be used as well.

A producing method of the respective layers of an organic EL device 100 includes, in addition to a vacuum deposition method, a CVD method, a sputtering method, and the like. Furthermore, as the coating method, various kinds of printing methods such as a gravure coating method, a gravure reverse coating method, a comma coating method, a die coating method, a lip coating method, a cast coating method, a roll coating method, an air-knife coating method, a mayer bar coating method, an extrusion coating method, an offset coating method, a UV-curing offset coating method, a flexo coating method, a stencil coating method, a silk coating method, a curtain flow coating method, a wire bar coating method, a reverse coating method, a gravure coating method, a kiss coating method, a blade coating method, a smooth coating method, a spray coating method, a solution casting method, and a brush coating method, may be applied. After a lower layer is dried to form a film, an upper layer is coated thereon. Further, the lower layer and the upper layer may be dried after the upper layer is superposed on the lower layer in a wet state.

### <Light-Emitting Mode of Organic EL Device>

A light-emitting mode of the organic EL device 100 will be described.

In the organic EL device 100, holes are transported from the positive electrode 14 to the hole injection layer 162 in the organic solid layer 16. The transported holes are injected into the hole transporting layer 164. The holes injected in the hole transporting layer 164 are transported to the light-emitting layer 166.

Furthermore, in the organic EL device 100, electrons are transported from the negative electrode 18 to the electron injection layer 168 in the organic solid layer 16. The transported electrons are injected into the electron transporting layer 167. The transported electrons are transported to the light-emitting layer 166.

The transported holes and electrons re-combine with each other in the light-emitting layer 166. Due to energy emitted at the re-combination, emission due to EL is generated. The emission is guided to the outside sequentially through the hole transporting layer 164, the hole injection layer 162, the positive electrode 14, the barrier film 12, and the substrate 10, and the emission can be observed.

When Al is used in the negative electrode 18, an interface between the negative electrode layer 18 and the electron transporting layer 168 becomes to a reflective layer. The emission is reflected by the interface, and proceeds toward the positive electrode 14, and goes through the substrate 10, and exited to the outside. Accordingly, when an organic EL device having the configuration as mentioned above is adopted in a display or the like, a substrate 10 side becomes to an observation surface of the display.

When, with organic EL display devices, the full-color display is intended to be realized, for instance, a producing method where organic EL devices emitting the respective colors of RGB are manufactured by separate coating (a separate coating method), a method where an organic EL device emitting a single color of white emission and a color filter are combined (a color filter method), a method where an organic EL device emitting a single color of blue emission or white emission and a color converting layer are combined (a color conversion method), and a method where an electro-magnetic wave is irradiated on an organic light-emitting layer which is a single color organic EL device or to realize a plurality of emissions (a photo-bleaching method), may be cited. However, in the exemplary embodiment, without particularly restricting, a method may be appropriately selected therefrom and used.

### EXAMPLES

In the following, the present invention will be more detailed with reference to examples and comparative examples. The present invention is not restricted to examples mentioned below, for instance, to a width, a pitch, a thickness and so on of a step structure.

### Example 1

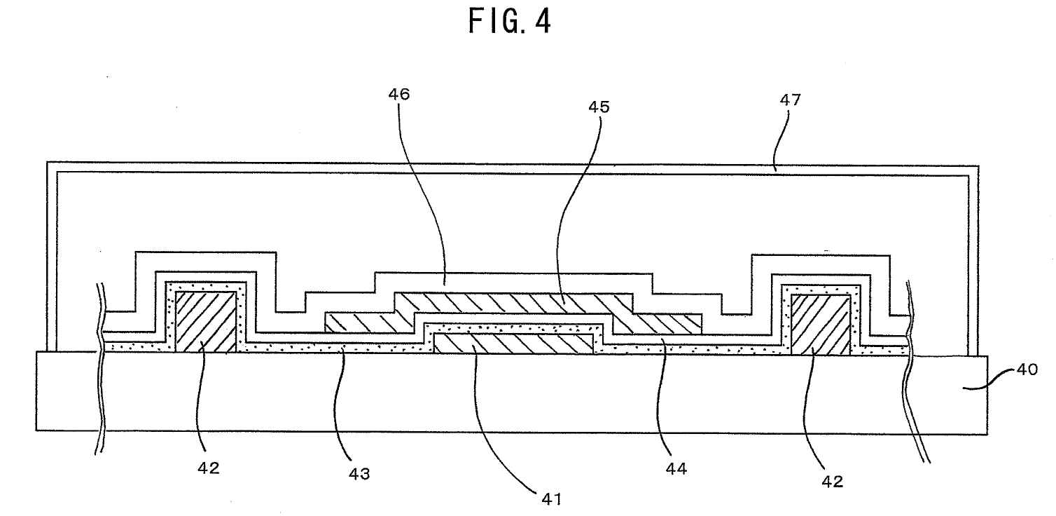

As shown in FIG. 4, on a glass substrate 40, ten (10) lines of positive electrode 41 made of ITO having a width of 50 μm, a pitch of 200 μm and a thickness of 115 nm were formed (FIG. 4 shows only one (1) line.). In the next place, between the positive electrodes 41 and 41, eleven (11) lines of step structure 42 having a width of 10 μm, a pitch of 200 μm and a thickness of 1.5 μm were formed with a photo-sensitive polyimide material (FIG. 4 shows two (2) lines.). Thereafter, a resulted one was set to a vacuum deposition apparatus, and, according to a usual vacuum deposition method, a hole injection layer 43 made of CuPc was deposited to a thickness of 25 nm, followed by further depositing a hole transporting layer 44 made of α-NPD to a thickness of 45 nm. Here, in the example 1, on a surface of the step structure 42 as well, the hole injection layer 43 and the hole transporting layer 44 were deposited. However, since it is sufficient that a height of the final step structure is formed to be higher than a height of a portion that is transferred, there is no particular problem.

In the next place, in a LITI transfer apparatus in a nitrogen atmosphere, a donor sheet on which Alq₃ was evenly deposited over an entire sheet to a thickness of 60 nm by means of a vacuum deposition method was placed so that the hole transporting layer 44 and Alq₃ come into close contact with each other. Then, an Alq₃ film 45 was thermal-transferred at a width of 120 μm and under laser power of 1.2 J/cm² so that a positive electrode 41 is at a center. Furthermore, a substrate on which Alq₃ was transferred was again set in a vacuum deposition apparatus, followed by depositing LiF to a thickness of 0.2 nm (not shown in the drawing), and further, followed by depositing a negative electrode 46 made of Al to a thickness of 100 nm.

At the last, according to a usual method, a sealing can 47 was used to seal an entirety, thereby an organic EL display device of example 1 was completed.

### Comparative Example 1

Except that, in the example 1, a step structure 42 was not formed, similarly to example 1 in all other steps, an organic EL display device of comparative example 1 was completed.

### (Result)

As the result of a comparison of an organic EL display device of the example 1 and an organic EL display device of comparative example 1, it was found that, while, in an organic EL display device of example 1, Alq₃ was uniformly formed only in a desired region and an excellent emission state was obtained, in an organic EL display device of comparative example 1, the mass transfer phenomenon was caused in a region other than a desired region, uniform emission of a device could not be obtained, and further, the other colors could not be separately coated.

1. A producing method of a transfer body with an organic film thermal-transferred thereon, comprising:
applying heat energy on an organic film-forming body on a surface of which an organic film is formed, to thermal-transfer the formed organic film from a surface of the organic film-forming body to a surface of a thermal transfer receptor to produce a transfer body with an organic film thermal-transferred thereon,
wherein, as to a surface of the thermal transfer receptor, a step structure formed higher than an outer edge of a position of the thermal transfer receptor before the thermal transfer is disposed at least partially on the outside of an outer edge of a position of the thermal transfer receptor, and
the organic film is thermal-transferred on a surface of a thermal transfer receptor to form a transfer body with an organic film thermal-transferred thereon.

2. The producing method of a transfer body with an organic film thermal-transferred thereon of claim 1,
wherein the thermal energy supplies light energy, and the supplied light energy is converted to thermal energy to apply the thermal transfer.

3. The producing method of a transfer body with an organic film thermal-transferred thereon of claim 2,
wherein the light energy is supplied by irradiating a laser beam.

4. The producing method of a transfer body with an organic film thermal-transferred thereon of claim 1,
wherein the step structure is formed by disposing a convex portion on a surface of the thermal transfer receptor.

5. The producing method of a transfer body with an organic film thermal-transferred thereon of claim 1,
wherein the thermal transfer receptor is a glass substrate or a resin substrate.

6. The producing method of a transfer body with an organic film thermal-transferred thereon of claim 1,
wherein the organic film is an organic film which is used to produce an organic EL display device.

7. A transfer body with an organic film thermal-transferred thereon, which is formed by applying heat energy on an organic film-forming body on a surface of which an organic film is formed to thermal-transfer the formed organic film from a surface of the organic film-forming body to a surface of a thermal transfer receptor,
wherein, as to a surface of the thermal transfer receptor, a step structure formed higher than an outer edge of a position of the thermal transfer receptor before the thermal-transfer is disposed at least partially on the outside of an outer edge of a position of the thermal transfer receptor.
